(19) United States
(12) Patent Application Publication
(10) Pub. No.: US 2016/0376010 A1
(43) Pub. Date: Dec. 29, 2016

(54) SYSTEMS AND METHODS FOR PREVENTING ICE ACCUMULATION

(71) Applicant: ROSEMOUNT AEROSPACE INC., BURNSVILLE, MN (US)

(72) Inventors: Matthew James-Thomas Gmach, Eagan, MN (US); Robert Edward Sable, Lakeville, MN (US); Scott Wigen, Eagan, MN (US); Matthew John Kunkel, Minneapolis, MN (US)

(21) Appl. No.: 15/165,264

(22) Filed: May 26, 2016

Related U.S. Application Data
(60) Provisional application No. 62/185,224, filed on Jun. 26, 2015.

(51) Int. Cl. B64D 15/04

(52) U.S. Cl. CPC B64D 15/04

(57) ABSTRACT

A device configured to prevent ice accumulation includes at least one wall defining a leading edge and a pneumatic passage configured to receive pressurized fluid. The device also includes at least one ejection port formed in at least one of the leading edge and the at least one wall, the at least one ejection portion fluidly coupled to the pneumatic passage to receive the pressurized fluid therefrom, the at least one ejection port configured to form fluid jets to divert liquid water droplets away from the leading edge of the device.

### CROSS REFERENCE TO RELATED APPLICATIONS

This application claims the benefit of an earlier filing date from U.S. Provisional Application Ser. No. 62/185,224 filed Jun. 26, 2015, the entire disclosure of which is incorporated herein by reference.

### FIELD OF INVENTION

The subject matter disclosed herein relates to vehicle sensors and, more specifically, to systems to prevent ice accumulation on vehicle sensors.

### BACKGROUND

Throughout operation, aircraft sensors or probes may accumulate unacceptable amounts of ice, which may cause damage to engine or other component aft of the sensor due to ice shedding events. Some known engine temperature sensors utilize some form of anti-icing heat to prevent or limit the size of ice accretion. However, electrical heating elements may reduce the life span of the probes, and pneumatically anti-iced probes may utilize only a fraction of available energy which can result in poor anti-icing.

Accordingly, it is desirable to provide system to improve anti-icing of vehicle sensors or probes.

### BRIEF DESCRIPTION

In one aspect, a device configured to prevent ice accumulation is disclosed. The device includes at least one wall defining a leading edge and a pneumatic passage configured to receive pressurized fluid. The device also includes at least one ejection port formed in at least one of the leading edge and the at least one wall, the at least one ejection portion fluidly coupled to the pneumatic passage to receive the pressurized fluid therefrom, the at least one ejection port configured to form fluid jets to divert liquid water droplets away from the leading edge of the device.

In another aspect, a probe assembly that includes a base platform, a probe coupled to the base platform, and a device coupled to at least one of the base platform and the probe is disclosed. The device is configured to be positioned in an airflow upstream of the probe and to prevent ice accumulation thereon and includes at least one wall defining a leading edge, a pneumatic passage configured to receive pressurized fluid and at least one ejection port formed in at least one of the leading edge and the at least one wall, the at least one ejection portion fluidly coupled to the pneumatic passage to receive the pressurized fluid therefrom, the at least one ejection port configured to form heated fluid jets to divert liquid water droplets away from the leading edge of the device.

Also disclosed is an aircraft engine that includes a housing, a fan, a compressor and a probe assembly disposed upstream of the compressor. The probe assembly includes a base platform, a probe coupled to the base platform, and a device coupled to at least one of the base platform and the probe, the device configured to be positioned in an airflow upstream of the probe and to prevent ice accumulation thereon. The device includes at least one wall defining a leading edge, a pneumatic passage configured to receive pressurized fluid, and at least one ejection port formed in at least one of the leading edge and the at least one wall, the at least one ejection portion fluidly coupled to the pneumatic passage to receive the pressurized fluid therefrom, the at least one ejection port configured to form heated fluid jets to divert liquid water droplets away from the leading edge of the device.

### BRIEF DESCRIPTION OF THE DRAWINGS

The foregoing and other features, and advantages of embodiments are apparent from the following detailed description taken in conjunction with the accompanying drawings in which:

FIG. 1 is a cross-sectional view of an aircraft engine having probe assembly according to one embodiment;

FIG. 2 is perspective view of the assembly shown in FIG. 1;

FIG. 3 is a perspective view of an ice accumulation prevention device that may be utilized with the assembly shown in FIGS. 1 and 2;

FIG. 4 is a plan view of the device shown in FIG. 3;

FIG. 5 is a plan view of an ice accumulation prevention device according to another embodiment;

FIG. 6 is a perspective view of a probe assembly according to yet another embodiment;

FIG. 7 is a perspective view of a probe assembly according to yet another embodiment;

FIG. 8 is a perspective view of a probe assembly according to yet another embodiment;

FIG. 9 is a perspective view of a probe assembly according to yet another embodiment; and

FIG. 10 is a perspective view of a probe assembly according to yet another embodiment.

### DETAILED DESCRIPTION

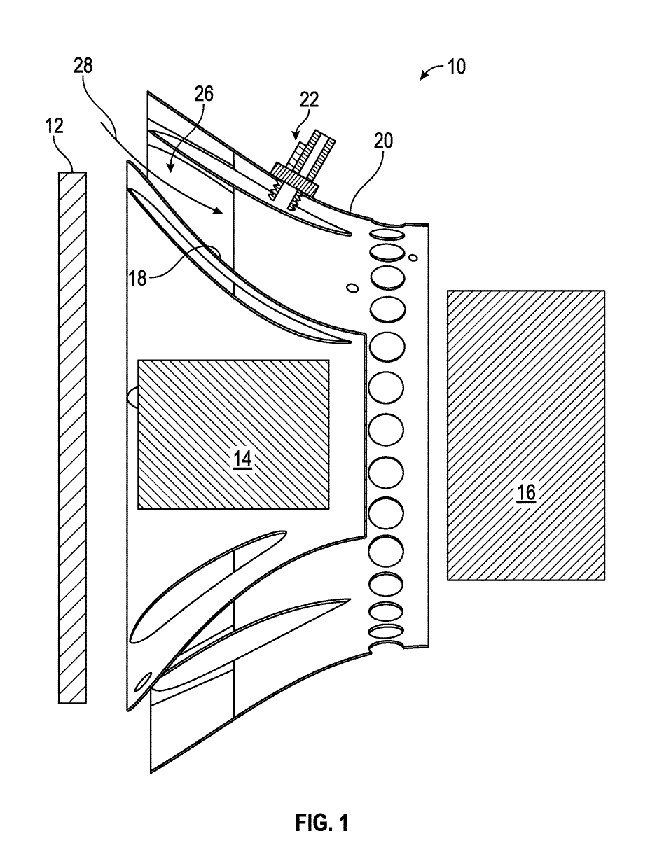

FIG. 1 illustrates a portion of an aircraft engine 10 that generally includes a fan 12, a low-pressure compressor 14, a high-pressure compressor 16, an inner case 18, an outer case 20, and a sensor or probe assembly 22 that includes an ice accumulation prevention device 24.

In the illustrated embodiment, probe assembly 22 is coupled to and extends through outer case 20 into a cavity 26 formed between inner case 18 and outer case 20. Cavity 26 is configured to direct an airflow 28 across probe assembly 22 to high-pressure compressor 16. Probe assembly 22 is configured to measure a parameter of airflow 28 such as temperature. Although ice accumulation prevention device 24 is illustrated with aircraft engine 10, device 24 may be utilized in various other locations of an aircraft or with other vehicles to prevent ice accumulation on an object.

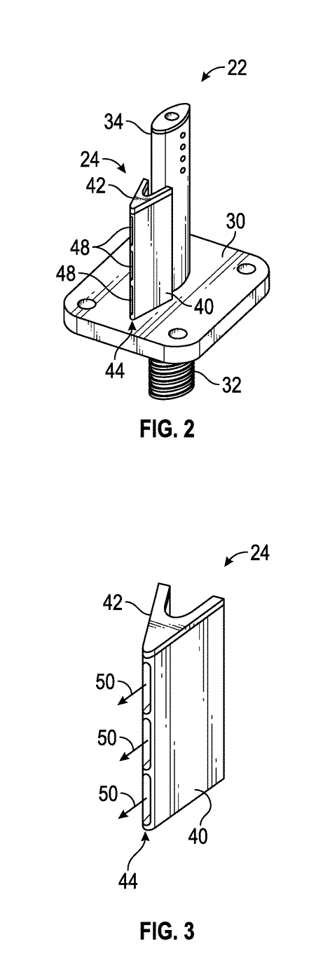

With reference to FIG. 2, probe assembly 22 includes a base platform 30, pneumatic connector 36, and electrical connector 32, a probe housing 34 that houses a probe element (not shown), and ice accumulation reduction device 24. Base platform 30 is configured to couple to a vehicle component such as engine outer case 20. Connector 32 provides a conduit for an electrical or signal communication to the probe element such as an electrical wire. Connector 36 provides a pneumatic connection to device 24, which receives a heated, pressurized fluid (e.g., air) from a source such as the compressor section of engine 10. Probe housing 34 is configured to couple to base platform 30, and the probe element is disposed within probe housing 34 and configured to sense a parameter or condition of the air passing thereby.

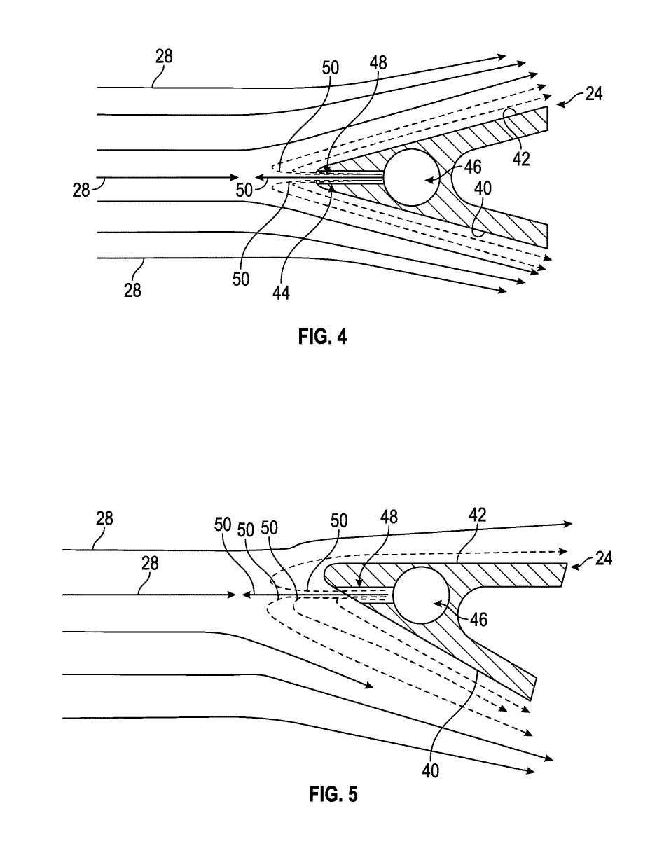

With reference to FIGS. 3 and 4, ice accumulation prevention device 24 is generally wedge-shaped and is positioned upstream of probe housing 34 to form a probe assembly. As such, airflow 28 passes over device 24 before probe housing 34. Device 24 generally includes converging first and second walls 40, 42, a leading edge 44, a pneumatic passage 46 (FIG. 4), and one or more ejection port 48. Pneumatic passage 46 is fluidly coupled to pneumatic connector 36 and receives the heated, pressurized fluid therefrom.

Ejection ports 48 are formed in leading edge 44 and are fluidly coupled to passage 46 to receive the heated, pressurized air. In the illustrated embodiment, ports 48 are elongated slots. However, ports 48 may have any suitable shape that enables device 24 to function as described herein. For example, ports 48 may be circular. Ejection ports 48 are configured to produce heated, pressurized fluid or air jets 50, and to direct jets 50 into air flow 28. Accordingly, as illustrated in FIG. 4, airflow 28 and water droplets contained therein are directed around walls 40, 42, thereby preventing the water droplets from contacting and building up as ice on probe housing 34 or device 24. Moreover, the heated air heats leadings edge 44, walls 40, 42, and/or other portions of device 24, which further prevents ice accumulation thereon.

FIG. 5 illustrates an ice accumulation prevention device 124 that is similar to device 24 except it includes ejection ports 148 formed in first wall 40 rather than in leading edge 44.

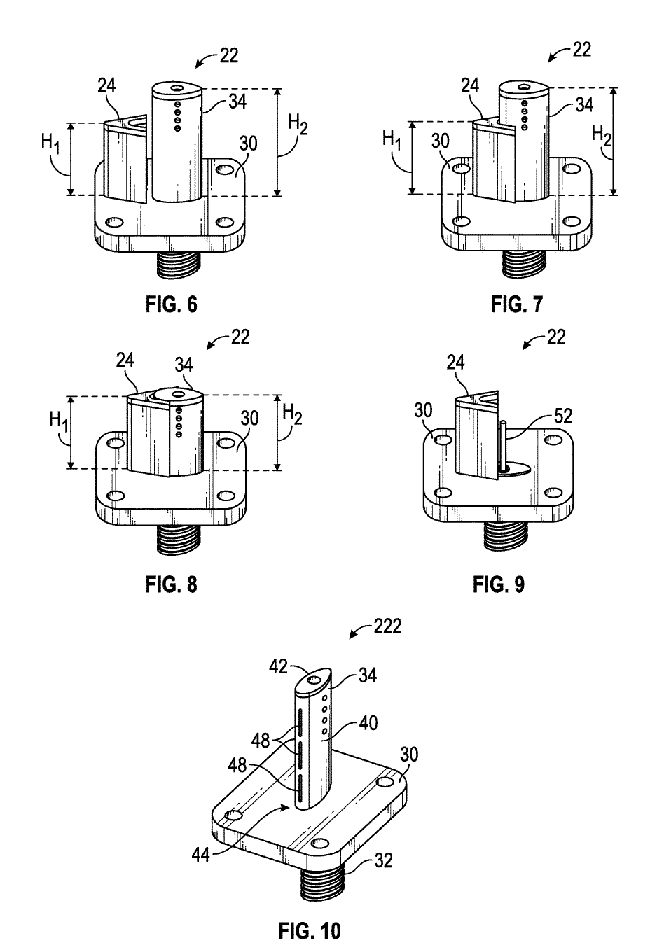

FIG. 6 illustrates an arrangement where ice accumulation prevention device 24 is coupled to base platform 30 in spaced relation to probe housing 34. FIG. 7 illustrates an arrangement where device 24 is coupled to both base platform 30 and probe housing 34. As such, portions of device 24 may have a shape that is complementary to a shape of probe housing 34. In both FIGS. 6 and 7, a height H1 of device 24 is less than a height H2 of probe housing 34. FIG. 8 illustrates an arrangement where H1 is equal to H2. FIG. 9 illustrates an arrangement where probe assembly 22 does not include a probe housing 34. As such, device 24 is disposed upstream of a probe element 52.

FIG. 10 illustrates a probe assembly 222 integrated with the features of the ice accumulation prevention device. In the illustrated embodiment, pneumatic passage 46 and ejection ports 48 are formed in probe housing 34. As such, a separate ice accumulation prevention device is not required. As shown, probe housing 34 is generally airfoil or teardrop shaped. However, probe housing 34 may have any suitable shape that enables probe assembly 222 to function as described herein. For example, probe housing 34 may be wedge-shaped or elliptical.

Described herein are systems and methods for controlling preventing ice accumulation on an object such as a probe. An ice accumulation prevention device is disposed upstream of a probe that may accumulate ice thereon. The device is fluidly coupled to a fluid line to receive a heated, pressurized fluid such as air. The device includes ejection ports formed therein, and the heated, pressurized air is forced through the ports to form heated, air jets to divert liquid water droplets away from the leading edge of the device. Heat is transferred from the heated, pressurized fluid to portions of the device to prevent ice accumulation thereon. Accordingly, the device prevents ice accumulation of the probe or other object, which may cause damage to surrounding components during ice shedding events.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments have been described, it is to be understood that aspects of the disclosure may include only some of the described embodiments. Accordingly, the disclosure is not to be seen as limited by the foregoing description, but is only limited by the scope of the appended claims.

1. A device configured to prevent ice accumulation, the device comprising:
at least one wall defining a leading edge;
a pneumatic passage configured to receive pressurized fluid; and
at least one ejection port formed in at least one of the leading edge and the at least one wall, the at least one ejection portion fluidly coupled to the pneumatic passage to receive the pressurized fluid therefrom, the at least one ejection port configured to form fluid jets to divert liquid water droplets away from the leading edge of the device.

2. The device of claim 1, wherein the at least one wall includes converging first and second walls

3. The device of claim 1, wherein the device is wedge-shaped or the device is airfoil-shaped.

4. The device of claim 1, wherein the at least one ejection port is an elongated slot.

5. The device of claim 1, wherein the at least one ejection port is formed in the leading edge.

6. The device of claim 1, wherein the at least one ejection port is formed in the at least one wall at a location that is not at the leading edge.

7. The device of claim 1, wherein the pneumatic passage is configured to receive heated, pressurized air, and the at least one ejection port is configured to form heated air jets.

8. A probe assembly comprising:
a base platform;
a probe coupled to the base platform;
a device coupled to at least one of the base platform and the probe, the device configured to be positioned in an airflow upstream of the probe and to prevent ice accumulation thereon, the device comprising:
at least one wall defining a leading edge;
a pneumatic passage configured to receive pressurized fluid; and
at least one ejection port formed in at least one of the leading edge and the at least one wall, the at least one ejection portion fluidly coupled to the pneumatic passage to receive the pressurized fluid therefrom, the at least one ejection port configured to form heated fluid jets to divert liquid water droplets away from the leading edge of the device.

9. The assembly of claim 8, wherein the device is wedge-shaped.

10. The assembly of claim 8, wherein the device is airfoil-shaped.

11. The assembly of claim 8, wherein the at least one ejection port is an elongated slot.

12. The assembly of claim 8, wherein the at least one ejection port is formed in the leading edge.

13. The assembly of claim 8, wherein the at least one ejection port is formed in the at least one wall at a location that is not at the leading edge.

14. The assembly of claim 8, further comprising a pneumatic connector coupled to the base platform, the pneumatic connector fluidly coupled to the pneumatic passage.

15. An aircraft engine comprising:
a housing;
a fan;
a compressor; and
a probe assembly disposed upstream of the compressor, the probe assembly comprising:
a base platform;
a probe coupled to the base platform;
a device coupled to at least one of the base platform and the probe, the device configured to be positioned in an airflow upstream of the probe and to prevent ice accumulation thereon, the device comprising:
at least one wall defining a leading edge;
a pneumatic passage configured to receive pressurized fluid; and
at least one ejection port formed in at least one of the leading edge and the at least one wall, the at least one ejection portion fluidly coupled to the pneumatic passage to receive the pressurized fluid therefrom, the at least one ejection port configured to form heated fluid jets to divert liquid water droplets away from the leading edge of the device.

16. The aircraft engine of claim 15, wherein the at least one ejection port is formed in the leading edge.

17. The aircraft engine of claim 15, wherein the at least one ejection port is formed in the at least one wall at a location that is not at the leading edge.

18. The aircraft engine of claim 15, further comprising a pneumatic connector coupled to the base platform, the pneumatic connector fluidly coupled to the pneumatic passage.

19. The aircraft engine of claim 15, wherein the pneumatic passage is fluidly coupled to the compressor, wherein the pressurized air is heated and supplied by the compressor.
